(19) United States
(12) Patent Application Publication
(10) Pub. No.: US 2025/0242838 A1
(43) Pub. Date: Jul. 31, 2025

(54) Method and Device for Safeguarding Automatic Control of a Motor Vehicle

(71) Applicant: Bayerische Motoren Werke Aktiengesellschaft, Muenchen (DE)

(72) Inventor: Nicolas FRAIKIN, Silkeborg (DK)

(21) Appl. No.: 18/854,102

(22) PCT Filed: Mar. 20, 2023
(86) PCT No.: PCT/EP2023/056996

§ 371 Date: Oct. 4, 2024

(30) Foreign Application Priority Data
Apr. 21, 2022 (DE) 10 2022 109 626.2

(51) Int. Cl. B60W 60/00; B60W 40/02; B60W 50/00

(52) U.S. Cl. CPC B60W 60/0053; B60W 40/02; B60W 2050/0057; B60W 2420/54

(57) ABSTRACT

A method for safeguarding automatic control of a motor vehicle includes the steps of: detecting a noise from an area outside the motor vehicle; determining that the noise is indicative of a predetermined driving situation; and providing a signal to deactivate the automatic control.

### BACKGROUND AND SUMMARY

The invention relates to the automatic control of a motor vehicle. In particular, the invention relates to the identification of circumstances necessary for automatic control of the motor vehicle.

A motor vehicle can be automatically controlled by means of a control apparatus. The control can achieve a level of two or higher in the SAE standard J3016, and so the motor vehicle can be controlled by the control apparatus alone at least in certain driving maneuvers or driving situations. Until the control apparatus is able to operate without supervision in all conceivable situations, it is necessary to continually identify whether or not predetermined conditions under which the control can reliably operate exist.

By way of example, the automatic control may be deactivated inside a tunnel, because there it is not possible to determine a position of the motor vehicle on the basis of a receiver for signals from satellites of a navigation system (GNSS). The tunnel may be marked on a geographical map that describes a road network used by the motor vehicle. To evaluate whether the motor vehicle is in a tunnel, its geographical position needs to be determined and compared with the map data. Satellite-based position determination can also fail for other reasons, however, and so in the absence of it being possible to determine the position by GNSS it is not possible to identify with sufficient certainty whether or not the motor vehicle is in a tunnel.

A journey in a tunnel can also be identified on the basis of optical scanning of the surroundings using a camera. The camera can also be used to determine the position of the motor vehicle, however, in particular if autonomous control on a higher level requiring redundant position determination is performed.

To make identifying the existence of the conditions independent of the control, it is necessary to use a sensor that is not evaluated by the control apparatus. Such a sensor may have poor availability, in particular if the control apparatus fuses signals from multiple sensors that are present on board.

An object on which the invention is based is to provide an improved technique for independently identifying the existence of predetermined conditions under which the motor vehicle can be automatically controlled. The invention achieves the object by means of the subjects of the independent claims. Dependent claims provide preferred embodiments.

According to a first aspect, a method for safeguarding automatic control of a motor vehicle comprises steps of picking up a sound from an area outside the motor vehicle; identifying that the sound indicates a predetermined driving situation; and delivering a signal for deactivating the automatic control.

The automatic control can be deactivated in a predetermined driving situation in which the risk of incorrect control of the motor vehicle is known to be great. Advantageously, the identification of the driving situation on the basis of its acoustic signature is independent of control of the motor vehicle. The automatic control can operate on the basis of one or more sensors aboard the motor vehicle that are not affected by sounds in the surroundings of the motor vehicle. By separating the information sources for the situation identification from the position determination it is possible by and large to achieve increased functional safety of the automatic control. Operational safety of the motor vehicle can be improved.

It is particularly preferred that the driving situation comprises the use of a tunnel by the motor vehicle. In a tunnel, standard sensors whose signal can be taken as a basis for controlling the motor vehicle may not be available or may be unreliable. By way of example, the determination of a geographical position of the motor vehicle on the basis of a global satellite-assisted navigation system (GNSS) may not be available. Tunnels are often illuminated by sodium vapor lamps, the yellow light from which can hamper optical recognition of landmarks. As such, a yellow lane marking cannot be distinguished from a white one, for example. The completely independent identification of the journey through a tunnel allows the automatic control to be deactivated in good time irrespective of sensor errors.

A tunnel is understood herein to mean an artificial, substantially tubular cavity through which a road that the motor vehicle can use runs. Often, the tunnel is underground and is used to pass beneath obstacles such as hills, stretches of water or other transport routes. To erect such a tunnel, not only is it necessary to undermine the obstacle, but the resultant cavity also needs to be secured, panelled or lined. This is normally done using building materials that may later be visible inside the tunnel. However, a noise control tunnel, an arcade or a building for mounting solar cells may also be involved. In such cases, the tunnel is not always completely enclosed and may be open or accessible at the top or side.

In a variant, the tunnel considered may be a location that encompasses a road on which the vehicle is travelling in such a way that reception of GNSS signals for position determination is not possible. Optionally, such a location can be considered to be a tunnel only from a predetermined extent along a direction of travel of the road.

The existence of the driving situation can be identified on the basis of a frequency spectrum of the sound. The frequency spectrum may be limited to a predetermined frequency range and specify what frequency is represented at what level. Moreover, a time characteristic of the frequency spectrum can be considered in order to identify the journey through a tunnel.

A volume of the sound can also be evaluated. The quieter the sound is, the further away the vehicle may be from side walls of a tunnel. If the volume of the sound drops below a predetermined threshold value, the hypothesis of a tunnel can be dismissed.

It is also preferred that the existence of the driving situation is identified on the basis of relative levels of the sound in predetermined frequency bands. The levels in the frequency bands can advantageously be ascertained by means of a Fourier transformation. An acoustic signature that indicates a journey through a tunnel can thus be identified with good certainty.

The existence of the driving situation can be identified on the basis of a change in the sound, which indicates the beginning or end of the driving situation. By way of example, an ambient sound of the motor vehicle can change in a characteristic manner while entering or exiting a tunnel. A type or speed of the change can be considered on the basis of a speed of travel of the motor vehicle. If the change does not correspond to the speed of travel, a different acoustic effect than a tunnel may be involved. The control can be deactivated when the driving situation is recognized as being entered, and enabled or reactivated again when it is exited.

In a more preferred embodiment, the existence of the driving situation is identified by means of machine learning. This can be accomplished, by way of example, by training an artificial neural network (ANN) to recognize a sound that indicates the predetermined driving situation. The ANN can be trained in predetermined driving situations by means of supervised learning. An input layer of the ANN can have sensor signals from a microphone or preprocessed signals applied to it, for example data representing the frequency spectrum of the sound.

In another embodiment, it is additionally identified that a geographical position of the motor vehicle cannot be determined by means of a receiver for signals of a satellite-assisted radio navigation system.

In particular if the predetermined driving situation comprises a journey through a tunnel in which reception of satellite signals is not possible, this can be evaluated as an additional indication.

According to another aspect, an apparatus for safeguarding automatic control of a motor vehicle comprises a sensor for picking up a sound from an area outside the motor vehicle; a processing device for identifying that the sound indicates a predetermined driving situation; and an interface for delivering a signal for deactivating the automatic control.

The processing device may be configured to carry out all or part of a method described herein. To this end, the processing device can comprise a programmable microcomputer or microcontroller and the method can be available in the form of a computer program product containing program code means. The computer program product may also be stored on a computer-readable data carrier. Features or advantages of the method can apply to the apparatus, or vice versa.

In one embodiment, the sensor comprises a microphone configured to pick up a sound outside the motor vehicle. By way of example, the sensor can comprise an exterior microphone, which can optionally be used in another application to pick up a voice command from a person in the surroundings of the stationary motor vehicle. In another embodiment, the sensor comprises a microphone in an interior of the motor vehicle. The interior can form in particular a passenger compartment or cabin. The microphone may be configured to sample speech from a person aboard the motor vehicle, for example as part of a hands-free system, automatic voice recognition or voice control. As such, an already existing microphone can advantageously be used to implement a technique described herein. In yet another embodiment, signals from multiple sensors can be evaluated, each of said sensors being configured to sample sounds from an area outside the motor vehicle.

According to yet another embodiment of the present invention, a motor vehicle comprises an automatic control apparatus and an apparatus described herein.

The invention will now be described in more detail with reference to the accompanying drawings.

### BRIEF DESCRIPTION OF THE DRAWINGS

FIG. 1 illustrates a motor vehicle in a predetermined driving situation; and

FIG. 2 illustrates a flowchart for a method.

### DETAILED DESCRIPTION OF THE DRAWINGS

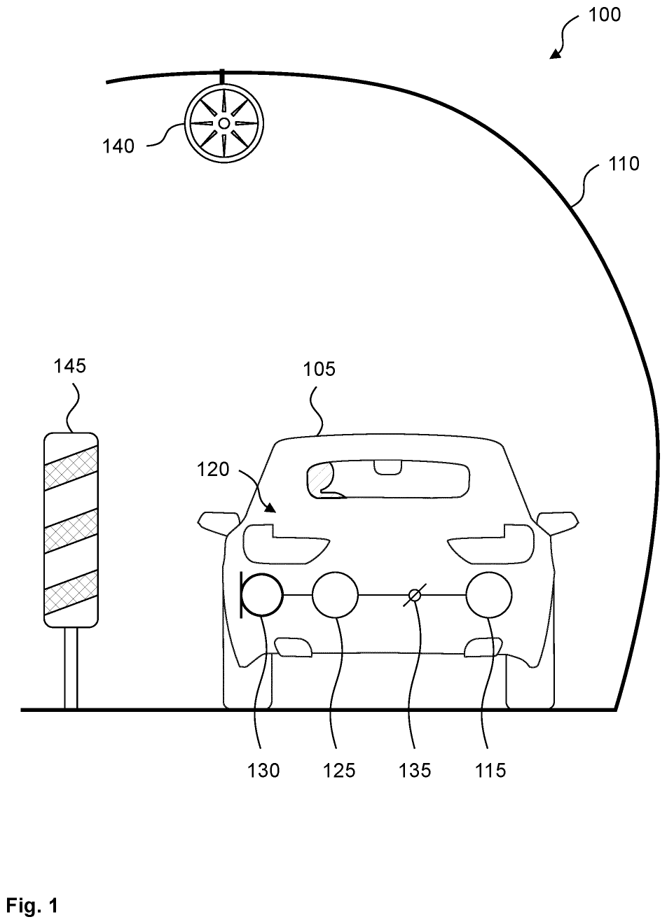

FIG. 1 shows a system 100 having a motor vehicle 105 in a predetermined driving situation. By way of illustration, the driving situation comprises a journey through a tunnel 110.

Aboard the motor vehicle 105 is a control apparatus 115 configured to control the motor vehicle 105 in the longitudinal direction and/or in the lateral direction. Control can preferably be carried out on one of levels two to four. This means that the motor vehicle 105 can be controlled by the control apparatus 115 only under predetermined conditions, which do not exist in the predetermined driving situation.

Additionally, there is provision aboard the motor vehicle 105 for an apparatus 120 configured to deliver a signal for deactivating the automatic control of the motor vehicle 105 to the control apparatus 115 if the motor vehicle 105 is in the predetermined driving situation. It should be noted that multiple different driving situations can also be evaluated to shut down the automatic control. A processing device 125 preferably comprises a general-purpose computing machine in the style of a computer.

The processing device 125 can also represent a device that is capable of machine learning or that implements learned behavior. Such a device can comprise an ANN, in particular. A microphone 130 is configured to pick up a sound that is audible in an area outside the motor vehicle 105. Preferably, the sensor 130 comprises an exterior microphone, but in another embodiment it can also comprise an interior microphone. An interface 135 may be in the form of a physical interface or in the form of a software interface if the processing device 125 and the control apparatus 115 are integrated with one another.

When the motor vehicle 105 is travelling through the tunnel 110, a soundscape effective outside the motor vehicle 105 can indicate the tunnel 110. By way of example, the tunnel 110 can contain an active sound source 140, the sounds from which indicate a journey through the tunnel 110. Such a sound source 140 can comprise the depicted fan, for instance.

Additionally, a driving sound caused by the moving motor vehicle 105 can be returned to the motor vehicle 105 in the tunnel 110 in a predetermined manner, this being able to be understood as a passive sound source. As such, for example, a rolling sound from a tire or an operating sound from a drive motor of the motor vehicle 105 can be reflected from a wall of the tunnel 110 or from an object 145 that may be encountered in the tunnel 110.

In the embodiment depicted, the object 145 comprises a beacon; in other embodiments, it can comprise, for example, a column, a strut, a safe room or an emergency door. Objects 145 may be arranged at predetermined distances in the tunnel 110, so that their sequence on passing can provide an additional indication of a journey in the tunnel 110.

It is proposed that the apparatus 120 pick up and analyze sounds from the surroundings of the motor vehicle 105 by means of the sensor 130 in order to identify whether the motor vehicle 105 is in the predetermined driving situation. The control apparatus 115 preferably disregards acoustic signals from the surroundings of the motor vehicle 105. The existence of the predetermined driving situation can therefore be identified completely independently of the control of the motor vehicle 105. The identification that the motor vehicle 105 is in a tunnel 110 can be improved even further by bearing in mind that radio signals from navigation satellites are normally not able to be received in the tunnel 110. A journey through the tunnel 110 can be identified only when, in addition to an appropriate acoustic signature, it has also been identified that satellite signals cannot be received, or a position of the motor vehicle 105 cannot be determined on the basis of such satellite signals.

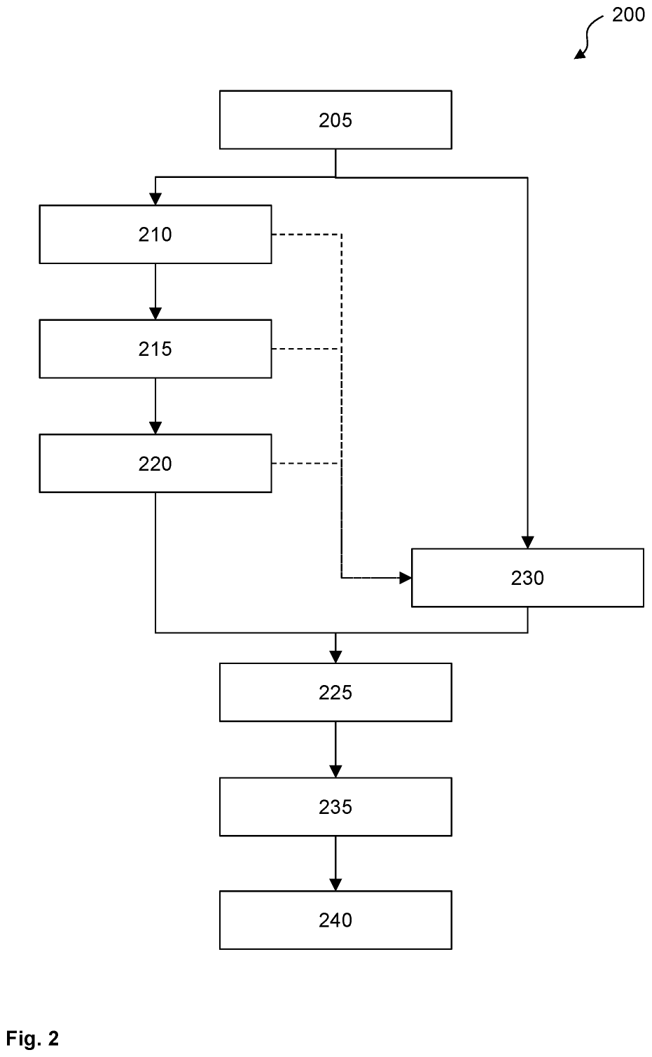

FIG. 2 shows a flowchart for a method 200 for monitoring a control apparatus 115 for controlling a motor vehicle 105. In a step 205, a sound from the surroundings of the motor vehicle 105 can be picked up. In a subsequent step 210, the picked-up sound can be split into predetermined frequency bands. The frequency bands are preferably in a range audible to the human ear and may be evenly or unevenly distributed. In a step 215, relative levels of the sound in the different frequency bands can be ascertained. Steps 210 and 215 can comprise performing a Fourier transformation.

Optionally, in a step 220, a time characteristic of the sound or the ascertained characteristics can be identified. This is accomplished by more preferably considering a change in the sound over a period, for example approximately five seconds, more preferably approximately two seconds.

In a step 225, it is then possible to ascertain whether a predetermined driving situation can be identified on the basis of the picked-up sound. This can be accomplished by comparing the ascertained characteristics with predetermined threshold values or predetermined patterns. In another embodiment, the sound can also be examined by means of machine learning methods to establish whether it indicates a journey by the motor vehicle 105 in a predetermined driving situation.

To this end, in a step 230, the sound can be recognized by means of an ANN, for example. The recognition can be based on the original sound from the scanning from step 205 or on a partially processed version from one of steps 210 to 220. In a first embodiment, it is possible to recognize whether or not the motor vehicle 105 is in the predetermined driving situation. In another embodiment, one or more characteristic sounds that indicate a journey in the predetermined driving situation can be identified. The sound-based recognition of the predetermined driving situation in step 225 can take into account results both from steps 210 to 220 and from the sound recognition by means of machine learning in step 230.

In a particularly preferred embodiment, in which the predetermined driving situation comprises a journey through a tunnel 110, a step 235 can comprise checking whether signals of a GNSS are available. If this is not the case, this can be seen as an indication of a journey in the tunnel 110. It should be noted that the absent signal can be evaluated as a necessary, rather than as a sufficient, feature for identifying the journey through the tunnel 110.

In step 240, a signal for deactivating the control of the motor vehicle 105 can be delivered if it has been identified that the predetermined driving situation exists. Should it be identified that the predetermined driving situation does not exist, on the other hand, the automatic control of the motor vehicle can be enabled. Optionally, the control can be reactivated if it has previously been deactivated.

### REFERENCE SIGNS

100 system
105 motor vehicle
110 tunnel
115 control apparatus
120 apparatus
125 processing device
130 sensor
135 interface
140 active sound source
145 object
200 method
205 pick up sound
210 split into frequency bands
215 ascertain relative levels
220 identify time characteristic
225 predetermined driving situation exists?
230 recognize sound
235 GNSS signal available?
240 deactivate control

1.-10. (canceled)

11. A method for safeguarding automatic control of a motor vehicle, the method comprising the steps of:
picking-up a sound from an area outside the motor vehicle;
identifying that the sound indicates a predetermined driving situation; and
delivering a signal for deactivating the automatic control when the sound indicates the predetermined driving situation.

12. The method according to claim 11, wherein the predetermined driving situation comprises use of a tunnel by the motor vehicle.

13. The method according to claim 11, wherein existence of the predetermined driving situation is identified based on a frequency spectrum of the sound.

14. The method according to claim 13, wherein the existence of the predetermined driving situation is identified based on relative levels of the sound in predetermined frequency bands.

15. The method according to claim 11, wherein the existence of the predetermined driving situation is identified based on a change in the sound, which indicates a beginning or an end of the predetermined driving situation.

16. The method according to claim 11, wherein the existence of the predetermined driving situation is identified via machine learning.

17. The method according to claim 11, further comprising the step of:
additionally identifying that a geographical position of the motor vehicle cannot be determined via a vehicle receiver for signals of a satellite-assisted radio navigation system.

18. An apparatus for safeguarding automatic control of a motor vehicle, the apparatus comprising:
a sensor for picking-up a sound from an area outside the motor vehicle;
a processor for identifying that the sound indicates a predetermined driving situation; and
an interface for delivering a signal for deactivating the automatic control when the processor identifies that the sound indicates the predetermined driving situation.

19. The apparatus according to claim 18, wherein the sensor comprises a microphone in an interior of the motor vehicle.

20. A motor vehicle, comprising:
an apparatus according to claim 18; and
an automatic control apparatus, wherein the signal deactivates the automatic control apparatus.
